(19) United States
(12) Patent Application Publication
(10) Pub. No.: US 2003/0163233 A1
(43) Pub. Date: Aug. 28, 2003

(54) Automatic vehicle management apparatus and method using wire and wireless communication network

(76) Inventors: Jin-Ho Song, Seoul (KR); Hu-Mor Hwang, Seongnam-City (KR)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/275,235

(22) PCT Filed: May 3, 2001
(86) PCT No.: PCT/KR01/00724

(30) Foreign Application Priority Data
May 4, 2000 (KR) 2000-23911
May 2, 2001 (KR) 2001-23761

(51) Int. Cl. G06F 19/00

(52) U.S. Cl. 701/33; 701/29

(57) ABSTRACT

Disclosed is an apparatus and method for automatic vehicle management using a wire/wireless communication network, the automatic vehicle management apparatus including: a vehicle data transmitter installed at an appropriate position on the inner or outer side of a motor vehicle for sending various data about the vehicle that is running; and a vehicle information control server for analyzing the vehicle data received from the vehicle data transmitter via the wire/wireless communication network to acquire information necessary for management of the vehicle, and providing the vehicle management information to a subscriber terminal in real time so as to perform vehicle management based on the information.

### BACKGROUND OF THE INVENTION

(a) Field of the Invention

The present invention relates to an apparatus and method for automatic vehicle management using a wire/wireless network. More specifically, the present invention relates to an apparatus and method for automatic vehicle management using a wire/wireless network that detects the mileage/location data of a running vehicle and the condition of principal equipment such as electronic devices to provide information necessary for the maintenance, operation and safety control of the vehicle for the individual subscriber, vehicle maintenance service agencies, or organs concerned, in real time, thereby guaranteeing efficient management of the vehicle.

(b) Description of the Related Art

Generally, vehicle maintenance and repair relies on off-line services in a manner such that the driver of a motor vehicle who recognizes a breakdown of the vehicle moves the vehicle to a nearby vehicle maintenance service agency and has the vehicle inspected and repaired. In such a case, efficient maintenance and repair of the vehicle can be achieved only if the driver has accurate information about the condition and defects of the vehicle.

To operate and maintain the vehicle, the driver has to check the vehicle periodically and replace used oils or parts each time the mileage of the vehicle reaches a predetermined value. In regard to car inspection, the driver must wait for issuance of a notice of the car inspection date, or take the trouble to memorize the inspection date.

Additionally, the driver has to renew the car insurance prior to its expiration date because car insurance is a prerequisite for providing against accidents. In renewal of the car insurance, the driver must wait for issuance of a notice related to the expiration date from the insurance company, or memorize the date.

Although a vehicle has a burglar alarm in provision against car theft, it is contrived to temporarily generate an alarm sound that may be sometimes hard to hear for the user who may be far away from the vehicle. Such a burglar alarm is useless in detecting the location of a stolen vehicle or the identity of the driver. Notification of a car accident is also impossible unless the driver or someone around the car reports the accident to the organ concerned, so that an accident that causes injury may unnecessarily take a human life, and it makes it difficult to find a car that undergoes an accident at an undetectable place.

Furthermore, there is no way to request rescue from the inside of the vehicle in an emergent situation such as a robbery or fire.

### SUMMARY OF THE INVENTION

Conventionally, the user of a motor vehicle has to take the trouble to memorize information necessary for vehicle maintenance, operation and control. Additionally, there is a need of a special method for safety control of vehicles.

It is therefore an object of the present invention to provide an apparatus and method for automatic vehicle management using a wire/wireless communication network that detects the mileage/location data of a running vehicle and the condition of principal equipment such as electronic devices to provide information necessary for the maintenance, operation and safety control of the vehicle for the individual subscriber, vehicle maintenance service agencies, or organs concerned, in real time, thereby guaranteeing efficient management of the vehicle.

In one aspect of the present invention, there is provided an apparatus for automatic vehicle management using a wire/wireless communication network that includes: a vehicle data transmitter installed at an appropriate position on an inner or outer side of a motor vehicle, for sending various data about the vehicle that is running; and a vehicle information control server for analyzing the vehicle data received from the vehicle data transmitter via the wire/wireless communication network to acquire information necessary for management of the vehicle, and providing the vehicle management information to a subscriber terminal in real time so as to perform vehicle management based on the information.

In another aspect of the present invention, there is provided a method for automatic vehicle management using a wire/wireless communication network that includes: (a) initializing a vehicle data transmitter for sending various data about a vehicle of each subscriber via the wire/wireless communication network, and a vehicle management server for receiving the various data from the. vehicle data transmitter and performing a vehicle management operation; (b) the vehicle data transmitter, automatically or by request of the vehicle management server, detecting a running condition of the subscriber's vehicle and sending corresponding data to the vehicle management server via the wire/wireless communication network; (c) the vehicle management server analyzing the data received from the vehicle data transmitter and performing the vehicle-related management operation together with the subscriber; and (d) the vehicle management server storing results of the vehicle-related management operation to continually perform the management operation.

Here, the vehicle-related management operation includes a vehicle maintenance-related management operation, a car accident-related management operation, a car theft-related management operation, an emergency-related management operation, a traffic information service-related management operation, a toll calculation-related management operation, an exhaust gas-related management operation, and a running record-related management operation.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic of an apparatus for automatic vehicle management using a wire/wireless communication network in accordance with an embodiment of the present invention;

FIG. 2 is a detailed block diagram of a mileage data module (MDM) in the vehicle management apparatus shown in FIG. 1;

FIG. 3 is a detailed block diagram of a vehicle information control server in the vehicle management apparatus shown in FIG. 1; and

FIGS. 4a and 4b are flow charts showing a method for automatic vehicle management using a wire/wireless communication network in accordance with an embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

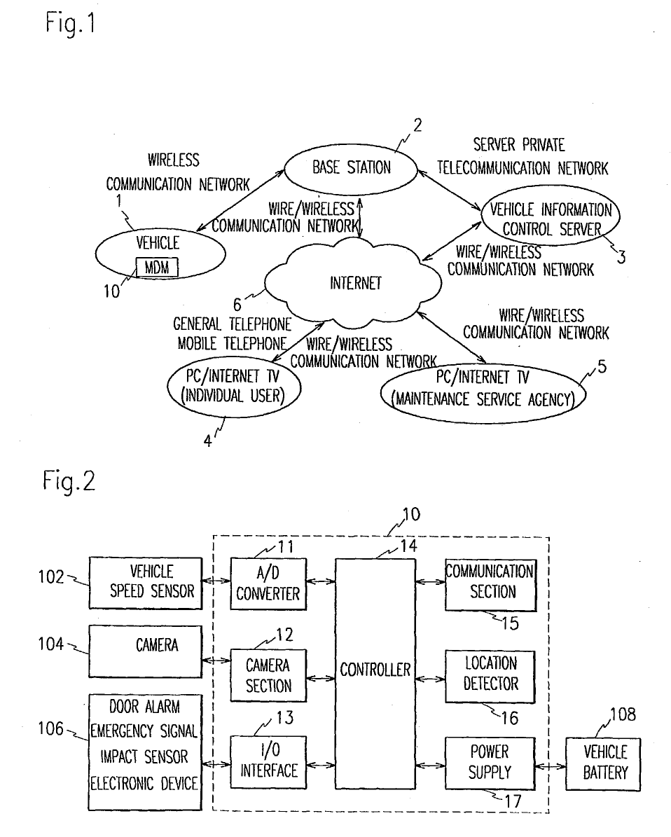

FIG. 1 is a schematic of an apparatus for automatic vehicle management using a wire/wireless communication network in accordance with an embodiment of the present invention.

The apparatus for automatic vehicle management using a wire/wireless communication network according to the embodiment of the present invention includes, as shown in FIG. 1, a mileage data module (MDM) 10 installed at an appropriate position in the inner/outer side of a motor vehicle 1 for determining the condition of the vehicle; and a vehicle information control server 3 for analyzing vehicle data received from the MDM 10 via a base station 2, which is connected to the MDM 10 in a wire/wireless manner, to get information for maintenance, operation and safety control of the vehicle, and providing the information to subscriber terminals 4 and 5 on the Internet 6.

The vehicle 1 is connected to the base station 2 via a wireless communication network by means of cellular transceiver, PSC, TRS or pager that is, a mobile telephone circuit systems, or a sender/receiver modem, the base station 2 being connected to the vehicle information control server 3 via the wire/wireless Internet 6 or a private telecommunication network server.

The subscriber terminals 4 and 5 include individual subscriber terminals 4 or terminals 5 of vehicle maintenance agencies or organs concerned that have subscribed for information from the vehicle information control server 3 on the Internet 6. The terminals 4 and 5 as used herein may be a display device mounted on PCs, Internet TVs or in motor vehicles, and are capable of being connected to the Internet in a wire/wireless manner for providing image information. The individual subscriber terminals 4 as used herein may include general wire/wireless telephones, mobile telephones, PDA terminals or GPS (Global Positioning System) terminals.

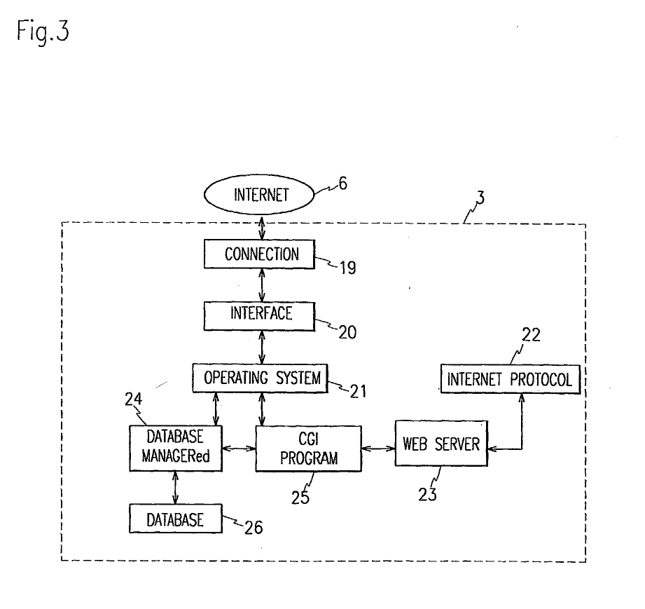

FIG. 2 is a detailed block diagram of the MDM 10 of the vehicle management apparatus shown in FIG. 1.

The MDM 10 includes, as shown in FIG. 2, an A/D converter 11 for converting speed data received from a speed sensor 102 of the vehicle to digital data; a camera section 12 for dealing with images of the driver's face; an I/O interface 13 for processing a door alarm signal, an emergency signal, an impact sensor signal, electronic device data, exhaust gas data, or the like; a communication section 15 having an RF module for wireless communication with the base station 2; a location detector 16 using the GPS to locate the vehicle; a power supply 17 for supplying driving power to the individual elements 11 to 16; and a controller 14 for wholly controlling the operations of the individual elements 11 to 16.

The above-constructed MDM 10 is installed at an appropriate position on the inner/outer side of the motor vehicle 1 to determine the condition of the vehicle. More specifically, the A/D converter 11 of the MDM 10 digitizes an analog pulse signal received from the speed sensor 102.

The speed sensor 102 as used herein may include a tachometer, a wheel spin sensor, an odometer, a hole sensor, etc.

The camera section 12 of the MDM 10 automatically takes a picture of the driver's face with a CCD camera 104 mounted in the vehicle and stores the image of the driver's face along with a predetermined number of image frames in the form of a still picture in the controller 14 for the sake of provision against a car accident, a car theft or other emergencies. The images are stored with a module using the CMOS IMAGER digital output method that adopts the Joint Photographers Expert Group (JPEG) as a compressed data format. The I/O interface 13 of the MDM 10 receives a door alarm signal from a door alarm actuated in the case of a car theft and various data from an emergency switch in an emergent situation, an impact sensor during a car accident, an exhaust gas sensor, and electronic devices such as an electronic control unit (ECU), and processes the received data under the control of the controller 14. Here, the controller 14 has a 32-bit micro-controller with built-in ROM, RAM, EEPROM, etc. and wholly controls the operations of the individual elements in the MDM 10. The camera section 12 and the location detector 16 adopt the RS-232 communication system to interface with the controller 14.

When the driver turns on the emergency switch, which is an ON/OFF switch, in an emergent situation including breakdown, car theft, fire, car accident, etc., the controller 14 sends the stored images of the driver's face, location data and emergency signal data to the vehicle information control server 3 via the base station connected to the communication section 15.

The controller 14 converts the data received from the A/D converter 11 to speed or mileage data and sends them together with the images of the driver's face, car accident data, theft signal data, condition data of the electronic devices, exhaust gas data, voice signal data of the driver, vehicle location data, or the like via the communication section 15.

The camera section 12 detects the contours and the features of the driver's face from the images and compares them to those of each registered driver's face. If the contours and the features of the driver's face in the images differ from those of each registered driver's face, the camera section 12 compresses the images of the driver's face and sends the compressed images to the vehicle information control server 3 via the base station 2.

In an unusual case, for example, where the camera is shielded or removed, or the driver wears a mask, the controller 14 detects the unusual situation and sends the detection result to the vehicle information control server 3.

The controller 14 has the self-learning ability to recognize unusual images of the driver's face with an algorithm using the neural network system. The controller 14 also has built-in speaker and voice CODEC so as to make use of the driver's voice signal for bi-directional traffic without hindrance in driving the vehicle.

The vehicle location information is sent to the communication section 15 via the GPS module built in the location detector 16. The communication section 15 modulates the vehicle data into a transmittable form via a 56 Kbps modem or the like and sends the data to the base station 2 via a cellular transceiver. Here, the use of the cellular transceiver is to provide for subsequent bidirectional communication. Data transmission with the cellular transceiver has an advantage in service coverage and price. Use is made of error detection and error correction codes for the purpose of reliable wireless communication: a simple retransmission method is used for transmission of a small amount of data, and a forward error correction code is used for a large amount of data.

The power supply 17 supplies a voltage of 12 V, 24 V or 32 V from a vehicle battery 108 to the individual elements 11 to 16 via a voltage regulator. For example, an operating voltage of 15 V is supplied to the communication section 15.

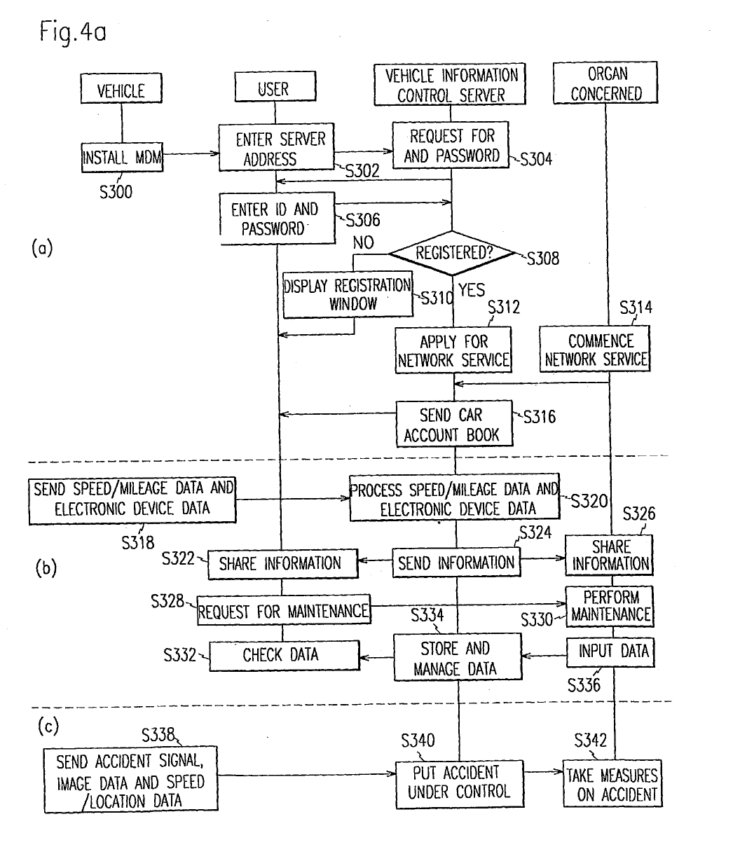

FIG. 3 is a detailed block diagram of the vehicle information control server 3 in the vehicle management apparatus shown in FIG. 1.

The vehicle information control server 3, as shown in FIG. 3, is constructed to be operative in association with the controller 14 of the MDM 10 and browsers of the subscriber terminals 4 and 5. That is, the vehicle information control server 3 includes a corinection 19 connected to the Internet 6, and an interface 20 that outputs an input content to the corresponding devices.

The vehicle information control server 3 also includes an operating system 21 and an Internet protocol 22 that operate the individual devices to process the input content from the interface 20.

The vehicle information control server 3 further includes a web server 23 operated on the Internet protocol 22 under the control of the operating system 21.

The web server 23 sends vehicle management data requested by the browsers of the subscriber terminals 4 and 5 in accordance with the HTTP (HyperText Transfer Protocol). The HTTP defines a communication protocol between the browsers and the server.

The operating system 21 has a built-in application program for assigning a message identifier for the MDM 10 so that the vehicle information control server 3 sends, if necessary, a call-out service message, such as a request for the images of the driver's face and transmission of the driver's voice signal, to the controller 14 of the MDM 10 via the IWF (Interworking Function). That is, the application program defines the identification procedure of the MDM 10, the message exchange procedure with the MDM 10 and the processing procedure of information received from the MDM 10.

The vehicle information control server 3 also includes a database 26 for storing vehicle information received from the MDM 10 and data processed by the operating system 21, and a database manager 24 for managing the database 26 under the control of the operating system 21.

The vehicle information control server 3 has a CGI (Common Gateway Interface) program 25 connected between the web server 23 and the operating system 21. The CGI program 25 provides and analyzes a CGI-based vehicle management program for users of the terminals 4 and 5. The CGI is to provide motion pictures and enable communication between the users and the server 3 via the browsers of the terminals 4 and 5.

The vehicle information control server 3 also has the database manager 24 between the CGI program 25 and the operating system 21. The database manager 24 operates under the control of the operating system 21 and outputs data necessary to the operation of the CGI program 25 with reference to the database 26, which is connected to the database manager 24.

The database 26 stores vehicle management data received via the database manager 24 and, if necessary, outputs the corresponding data to the database manager 24.

On the other hand, the base station 2, receiving data from the cellular transceiver, that is, the communication means of the MDM 10 mounted in the vehicle 1, sends the image or data information to the vehicle information control server 3 using the SMS and IWF method on the wire/wireless Internet 6 or the server private telecommunication network.

The vehicle information control server 3 analyzes the individual vehicle data received from the base station 2 to obtain information for maintenance, operation and safety control of each vehicle. That is, the vehicle information control server 3 analyzes the data listed in the A/S manual of each vehicle using the mileage data of the vehicle to provide the appropriate moment of inspection and replacement for vehicle maintenance in regard to oils and parts, such as engine oil, transmission oil, brake fluid, air filter, fuel filter, and the like. The vehicle information control server 3 also gives real-time traffic information by route or highway section to infer traffic congestion in connection to the speed data and location information of the vehicle, and information for automatic reckoning of a toll using the mileage data and location information in connection to a tollgate in/out signal.

In addition, the vehicle information control server 3 checks the date of car inspection and the expiration date of car insurance for each vehicle and gives information about the date of car inspection and the renewal date of car insurance to the owner of the vehicle.

With the emergency switch near the driver's seat turned ON, the vehicle information control server 3 analyzes the predefined emergency signal and the images of the driver's face to determine whether the vehicle is in an emergent situation, and notifies the organs concerned of the determination result.

With the door of the vehicle opened in an unusual way, the vehicle information control server 3 receives speed, image and location data as well as a door alarm signal via a door circuit connected to the MDM 10 and notifies the organ concerned that the vehicle is stolen. Upon receiving an accident signal from the impact sensor connected to the MDM 10 and image and location data other than the speed data of the vehicle, the vehicle information control server 3 reports a car accident to the organ concerned such as the 911 rescue corps.

In case of a need of car inspection and part replacement in connection with a service center, the vehicle information control server 3 notifies the subscriber terminal 5 as a registered vehicle maintenance agency of that need, so that the terminal 5 offers a necessary service to the user of the vehicle. The user of the vehicle and the service agency access the vehicle information control server 3 on the Internet via the terminals 4 and 5 to get necessary vehicle information. That is, the individual user or the vehicle maintenance service agency accesses the Internet with an ID given during registration to collect real-time information about the user's vehicle or a target vehicle to be served.

The vehicle maintenance service agency checks the current situation of the vehicle based on the information of the target vehicle received from the vehicle information control server 3 to provide service items necessary for the vehicle maintenance service to the user. Then, the user selects necessary service items and requests the corresponding maintenance service.

The vehicle information control server 3 sets an incentive system for vehicle maintenance service agencies to honestly keep a record of the served items in a subscriber's private car account book, which is automatically managed on the Internet, and to make out a reliable car history, thereby giving information necessary for the efficient trading of used cars. The vehicle information control server 3 may also give vehicle information to the user via the telephone.

The vehicle information control server 3 uses the speed data and location information of each vehicle to give vehicle running information of delivery companies, such as prearranged vehicle arrival time, scientific car allocation, and the like.

The vehicle information control server 3 also provides additional services requested by the user. For example, the user can get real-time information as well as all sorts of vehicle information, including Internet service, E-mail service, weather information, stock information, well-known restaurant information, or the like via different terminals mounted in the vehicle.

The vehicle information control server 3 analyzes the speed data received from each vehicle to plot or digitize by vehicle the speed-related information of specific vehicles, for example, freight cars that have an obligation to keep a record of running, and automatically sends the plotted or digitized results to the car inspection agencies or the users, thereby contributing to law-abiding driving.

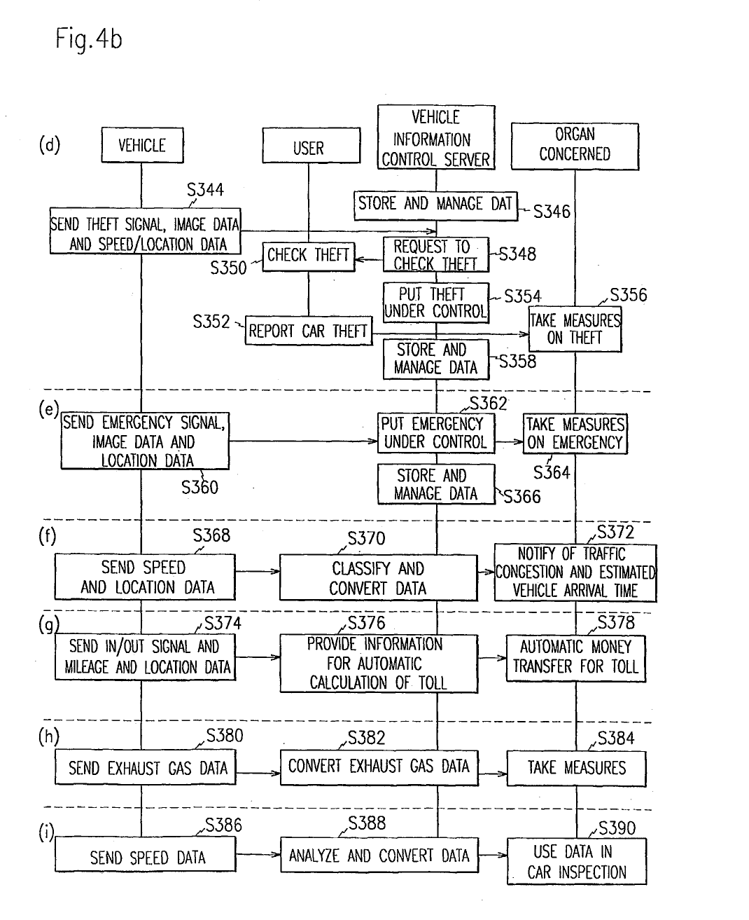

Hereinafter, a detailed description will be given of a method for automatic vehicle management using a wire/wireless communication network according to an embodiment of the present invention with reference to FIGS. 4a and 4b.

First, an initializing operation (a) in the method for automatic vehicle management using a wire/wireless communication network according to the embodiment of the present invention will be described.

An IP address for access to the Internet 6 is given to the MDM 10 mounted in each motor vehicle 1 via the IWF. The vehicle information control server 3 accesses the Internet 6 via the connection 19 so that the program on the Internet 6 assigns a domain name.

To access the Internet 6 and get information from the vehicle information control server 3, the user installs the MDM 10 in the motor vehicle 1, in step S300, and enters an address for access to the vehicle information control server 3, in step S302. The vehicle information control server 3 then requests the user to enter the user's ID and password, in step S304.

Once the user enters his/her ID and password, in step S306, the vehicle information control server 3 determines from the entered ID and password whether the user is a registered subscriber, in step S308.

If the user is not registered, the vehicle information control server 3 displays a registration window to the user and urges the user to register and re-enter the ID and password after registration, in step S310.

After identifying the user from the entered ID and password, the web server 23 of the vehicle information control server 3 requests the base station 2 to permit the access to the communication network, in step S312, and the base station 2 permits the access to the communication network, in step S314.

As the communication network is accessed, the web server 23 sends a car account book to the user on the Internet 6, in step S31 6.

Now, a description will be given of the vehicle management process performed using the automatic vehicle management method using a wire/wireless communication network according to an embodiment of the present invention.

First, a maintenance-related vehicle management process (b) will be described.

The MDM 10 mounted in the motor vehicle 1 sends speed/mileage data and electronic device data to the vehicle information control server 3 via the base station 2, in step S318. The vehicle information control server 3 then processes the speed/mileage data and the electronic device data into information necessary for vehicle maintenance by user, including car inspection and part replacement information, in step S320, and sends the information to the user and the vehicle maintenance service agency via the Internet 6, in step S324.

The user and the vehicle maintenance service agency store the information and share it, in steps S322 and S326. If necessary, the user requests maintenance service from the vehicle maintenance service agency, in step S328. On request for maintenance service, the vehicle maintenance service agency services the vehicle, in step S330, and enters the result data, in step S336. The vehicle information control server 3 stores the result data entered by the vehicle maintenance service agency in the database 26, in step S334. The user then checks the corresponding data, in step S332.

Now, an accident-related vehicle management process (c) will be described.

In a car accident, the MDM 10 mounted in the motor vehicle 1 sends car accident signal/image data and speed and location data to the vehicle information control server 3 in the above-described way, in step S338. Then, the vehicle information control server 3 analyzes the corresponding data, takes measures to deal with the accidental situation, and reports the accident to the police, in step S340. The organ concerned takes follow-up measures, in step S342, and the vehicle information control server 3 stores the result data in the database 26, in step S346.

Now, the car-theft-related vehicle management process (d) will be described.

Once the motor vehicle 1 is stolen, the MDM 10 mounted in the vehicle 1 sends a car theft signal/image data and speed and location data to the vehicle information control server 3 in the above-described way, in step S344. Then, the vehicle information control server 3 requests the user to ascertain the car theft, in step S348, and the user checks whether the vehicle is stolen, in step S350.

If the vehicle is stolen, the user notifies the car theft to the organ concerned, in step S352, and the organ concerned takes measures to deal with the situation, in step S356.

The vehicle information control server 3 assists the organ concerned to cope with the situation, in step S354, and stores the related data to the database 26, in step S358.

Now, an emergency-related vehicle management process (e) will be described.

In an emergent situation, the MDM 10 mounted in the motor vehicle 1 sends an emergency signal/image data and location data to the vehicle information control server 3 in the above-described way, in step S360. Then, the vehicle information control server 3 checks the emergent situation, takes measures to deal with the situation, and reports the emergent situation to the organ concerned, in step S362. The organ concerned also checks the emergent situation and takes appropriate emergency measures, in step S364. The vehicle information control server 3 stores the related data in the database 26, in step S366.

Next, a traffic information service-related vehicle management process (f) will be described.

As requested by the vehicle information control server 3, the MDM 10 mounted in the motor vehicle 1 sends speed and location data to the vehicle information control server 3, in step S368. Then, the vehicle information control server 3 processes the received data by region, road route and time and sends them to the organ concerned on the Internet 6, in step S370. The organ concerned announces the received data from the vehicle information control server 3 by use purpose so that the data are publicly used as location-specific traffic information, in step S372.

Now, a toll calculation-related vehicle management process (g) will be described.

The MDM 10 sends a tollgate in/out signal and mileage and location data to the vehicle information control server 3 in the above-described way, in step S374. Then, the vehicle information control server 3 processes the tollgate in/out signal and the mileage and location data to automatically calculate the toll (for example, on the highway) by vehicle and provides the result data to the organ concerned on the Internet 6, in step S376. The organ concerned takes measures by user to facilitate the users payment of the toll, for example, via automatic money transfer, based on the toll information received from the vehicle information control server 3, in step S378.

Now, an exhaust-gas-related vehicle management process (h) will be described.

As requested by the vehicle information control server 3, the MDM 10 sends exhaust gas data to the vehicle information control server 3, in step S380. Then, the vehicle information control server 3 processes the received data by vehicle, vehicle type, company, manufacturing year or season and sends them to the organ concerned on the Internet 6, in step S382. The organ concerned analyzes the exhaust-gas-related information received from the vehicle information control server 3 and takes appropriate measures, in step S384.

Finally, arunning record-related vehicle management process (i) will be described.

As requested by the vehicle information control server 3, the MDM 10 sends speed data to the vehicle information control server 3 with the volume of transmission reduced by data compression or the like in the above-described way, in step S386. Then, the vehicle information control server 3 analyzes and processes the received speed data from the MDM 10 and provides them to the organ concerned on the Internet 6, in step S388. The organ concerned makes use of the information related to the speed data from the vehicle information control server 3 as a running record of the periodic inspection of the vehicle, in step S390.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

In accordance with the present invention, the vehicle information control server detects data related to mileage and speed of running vehicles, condition of electronic devices, exhaust gas status, images of the driver's face, car theft information, car accident information, location of the vehicles and emergency signals in a manner of remote control, and gives information necessary for the maintenance, operation and safety control of vehicles to the users based on the detected data on the Internet in real time. Thus the present invention guarantees efficient management of vehicles, enables the user of the vehicle to effectively cope with safety control and contributes to provision of traffic information and reduced congestion of tollgates on the highway.

What is claimed is:

1. An apparatus for automatic vehicle management using a wire/wireless communication network, comprising:
a vehicle data transmitter installed at an appropriate position on an inner or outer side of a motor vehicle, for sending various data about the vehicle that is running; and
a vehicle information control server for analyzing the vehicle data received from the vehicle data transmitter via the wire/wireless communication network to acquire information necessary for management of the vehicle, and providing the vehicle management information to a subscriber terminal in real time so as to perform vehicle management based on the information.

2. The apparatus as claimed in claim 1, wherein the vehicle data transmitter comprises:
an A/D converter for converting a speed of the vehicle to speed data;
a camera section for processing images such as an image of a driver's face;
an I/O interface for processing a door alarm signal, an emergency signal, an impact sensor signal, electronic device data or exhaust gas data;
a location detector using a GPS (Global Positioning System) for determining a current location of the vehicle;
a communication section for sending data received from the A/D converter, the camera section, the 1/0 interface and the location detector to the vehicle information control server, and enabling bidirectional communication between a user and the vehicle information control server;
a power supply for supplying driving power to the A/D converter, the camera section, the 1/0 interface, the location detector, and the communication section; and
a controller for wholly controlling operation of the AID converter, the camera section, the 1/0 interface, the location detector, and the communication section.

3. The apparatus as claimed in claim 1, wherein the vehicle information control server comprises:
a connection being connected to the wire/wireless communication network;
an interface for outputting data received from the connection and an operating system;
a communication protocol for defining a method of data communication on the wire/wireless communication network;
a web server operated via the communication protocol, for sending vehicle information data to a browser of the subscriber terminal by request of the subscriber terminal;
a database for storing the vehicle information data received from the vehicle information control server and otherdata;
a database manager for managing the database;
a CGI (Common Gateway Interface) program, connected between the web server and the database manager, for providing an application program for a user of the subscriber terminal; and
an operating system, connected to the wire/wireless communication network as well as the database manager and the CGI program via the connection, for wholly controlling operation of the vehicle information control server.

4. The apparatus as claimed in claim 2, wherein the A/D converter converts an analog pulse signal received from a speed sensor to a digital signal and sends the digital signal to the controller.

5. The apparatus as claimed in claim 2, wherein the camera section comprises:
a camera for automatically taking a picture of the driver's face; and
means for compressing the image captured by the camera and comparing features of the driver's face in the image to those of a registered driver's face.

6. The apparatus as claimed in claim 2, wherein the I/O interface receives a door alarm signal generated when a car door is opened in an unusual way, an impact sensor signal generated in a car accident, an emergency signal generated in an emergent situation, data received from an exhaust gas sensor, and data about condition of electronic devices such as an ECU (Electronic Control Unit), and interfaces them in a form required by the controller.

7. The apparatus as claimed in claim 2, wherein the controller comprises a 32-bit micro-controller with a ROM, RAM or EEPROM, the controller converting the speed data received from the A/D converter to speed and mileage information;
the controller storing a compressed image from the camera section and sending the compressed image to the vehicle information control server via the communication section, if necessary, along with a predetermined number of frames in each case of a car accident, a car theft, or an emergent situation; and
the controller controlling the vehicle information control server to receive necessary information via the communication section in connection with the door alarm signal, the impact sensor signal, the emergency signal, the exhaust gas data, the electronic device data, the location data, speed/mileage information and the image information.

8. The apparatus as claimed in claim 2, wherein the communication section comprises:
a modem for modulating the vehicle data to a transmittable form and enabling bidirectional communication between the user and the vehicle information control server; and
a cellular transceiver, PCS, TRS or pager for sending the modulated vehicle data to a base station.

9. The apparatus as claimed in claim 2, wherein the power supply comprises a voltage regulator for regulating a battery voltage of the vehicle to a required voltage.

10. The apparatus as claimed in claim 1, wherein the vehicle information control server is connected to a base station in a wire/wireless way, the vehicle information controlling server analyzing vehicle-specific mileage data received via the base station and automatically providing necessary information to the subscriber terminal via the wire/wireless communication network, the information including mileage data for management of vehicle operation, and vehicle maintenance data related to such factors as dates of replacement and inspection in regard to engine oil, transmission oil, air filter, or fuel filter.

11. The apparatus as claimed in claim 1, wherein the vehicle information control server checks a date for car inspection and an expiration date of car insurance for registered vehicles, and automatically provides information about the date for car inspection and the renewal date of car insurance to the subscriber terminal.

12. The apparatus as claimed in claim 1, wherein the vehicle information control server analyzes door alarm data, condition data of electronic devices including an ECU, a tachometer and an impact sensor, image data of a driver's face and emergency signal data, all received from the vehicle data transmitter, to determine whether the vehicle is in a situation related to car theft, hijacking, fire, robbery or car accident, for the purpose of safety control of the vehicle, and notifies the subscriber terminal of the result of determination so that a user of the subscriber terminal takes measures to put the situation under control.

13. The apparatus as claimed in claim 1, wherein the subscriber terminal comprises various display devices for providing image information, the display devices being mounted in Internet-accessible computer systems, Internet TVs or motor vehicles' of individual users, vehicle maintenance service agencies, organs concerned, or associated companies, the subscriber terminal receiving mileage-based vehicle management information from the vehicle information control server and automatically providing the received vehicle management information to its user.

14. The apparatus as claimed in claim 13, wherein the subscriber terminal of an individual user further comprises a general wire/wireless telephone, a mobile telephone, a PDA terminal, or a GPS terminal.

15. The apparatus as claimed in claim 1, wherein only for specified vehicles such as freight cars that are under obligation to keep a record of running, the vehicle information control server analyzes speed information received from the vehicle data transmitter to plot the analyzed speed information into a graph, and automatically provides the plotted speed information to the subscriber terminal via the wire/wireless communication network so that the speed information can be used in a periodic car inspection.

16. The apparatus as claimed in claim 1, wherein the vehicle information control server processes exhaust gas data of the vehicle received from the vehicle data transmitter by vehicle, vehicle type, manufacturing company, manufacturing year, or season, and provides the processed exhaust gas data to the subscriber terminal via the wire/wireless communication network in real time so that the exhaust gas data can be used to improve the environment and the quality of vehicles.

17. The apparatus as claimed in claim 1, wherein the vehicle information control server provides speed and location data received from the vehicle data transmitter to the subscriber terminal via the wire/wireless communication network in real time so that the speed and location data can be used in connection with a tollgate in/out signal to automatically calculate a vehicle-based toll on a highway.

18. The apparatus as claimed in claim 1, wherein the vehicle information control.server processes mileage and location data of the vehicle received from the vehicle data transmitter by region, road route, or time, and provides the processed mileage and location data to the subscriber terminal via the wire/wireless communication network in real time so that a user of the subscriber terminal can infer traffic congestion and vehicle arrival time.

19. A method for automatic vehicle management using a wire/wireless communication network, comprising:
(a) initializing a vehicle data transmitter for sending various data about a vehicle of each subscriber via the wire/wireless communication network, and a vehicle management server for receiving the various data from the vehicle data transmitter and performing a vehicle management operation;
(b) the vehicle data transmitter, automatically or by request of the vehicle management server, detecting a running condition of the subscriber's vehicle and sending corresponding data to the vehicle management server via the wire/wireless communication network;
(c) the vehicle management server analyzing the data received from the vehicle data transmitter and performing the vehicle-related management operation together with the subscriber; and
(d) the vehicle management server storing a result of the vehicle-related management operation to continually perform the management operation on the subscriber's vehicle.

20. The method as claimed in claim 19, wherein the initializing step (a) comprises:
mounting the vehicle data transmitter at an appropriate position on the inner or outer side of the vehicle;
entering in the vehicle data transmitter an address of a server that provides vehicle-related information to the subscriber;
the vehicle management server using an ID and password entered by the subscriber to determine whether the subscriber is registered;
the vehicle management server requesting service of the wire/wireless communication network, when the subscriber is registered; and
the vehicle management server notifying the subscriber of the commencement of the vehicle management operation via the wire/wireless communication network.

21. The method as claimed in claim 19, wherein the vehicle-related management operation comprises a vehicle maintenance-related management operation, a car accident-related management operation, a car theft-related management operation, an emergency-related management operation, a traffic information service-related management operation, a toll calculation-related management operation, an exhaust gas-related management operation, and a running record-related management operation.

22. The method as claimed in claim 21, wherein the vehicle maintenance-related management operation comprises:
the vehicle data transmitter sending speed/mileage data and electronic device data of the vehicle to the vehicle management server;
the vehicle management server analyzing the received data, processing them into information necessary for vehicle-related maintenance including car inspection and part replacement, and sending them to the subscriber;
the subscriber performing maintenance of the vehicle based on information received from the vehicle management server; and
the vehicle management server storing the result of the vehicle maintenance.

23. The method as claimed in claim 21, wherein the car accident-related management operation comprises:
the vehicle data transmitter sending accident signal/image data and speed and location data to the vehicle management server when a car accident occurs;
the vehicle management server analyzing the received data, taking measures to cope with the car accident and reporting the car accident to an organ concerned so that the organ concerned takes follow-up measures; and
the vehicle management server storing the result of the measures taken to deal with.the car accident.

24. The method as claimed in claim 21, wherein the car theft-related management operation comprises:
the vehicle data transmitter sending theft signal/image data and speed and location data to the vehicle management server when a car theft occurs;
the vehicle management server using the received data to cause the subscriber to check whether the vehicle is stolen;
the vehicle management server reporting a car theft to an organ concerned such that the organ concerned takes measures to cope with the car theft, when the subscriber ascertains that the vehicle is stolen;
the vehicle management server using the data received from the vehicle data transmitter to help the organ concerned in taking measures for the car theft; and
the vehicle management server storing the result of the measures taken to deal with the car theft.

25. The method as claimed in claim 21, wherein the emergency-related management operation comprises:
the vehicle data transmitter sending emergency signal/image data and location data to the vehicle management server in an emergent situation related to a vehicle;
the vehicle management server using the received data to check the emergent situation, taking measures to cope with the emergent situation and reporting the emergent situation to an organ concerned to take appropriate measures; and
the vehicle management server storing the result of the measures taken to deal with the emergent situation.

26. The method as claimed in claim 21, wherein the traffic information service-related management operation comprises:
the vehicle management server requesting speed and location data of a vehicle from the vehicle data transmitter;
the vehicle data transmitter sending the requested speed and location data to the vehicle management server; and
the vehicle management server classifying and converting the received data by region, road route and time, and sending the converted data to an organ related to traffic information via the wire/wireless communication network so that the organ concerned publicly notifies of the data as traffic information at the current location of the vehicle.

27. The method as claimed in claim 21, wherein the toll calculation-related management operation comprises:
the vehicle data transmitter sending a tollgate in/out signal and mileage and location data to the vehicle management server; and
the vehicle management server analyzing and processing the received data into toll information and sending the toll information to an organ related to toll calculation so that the organ takes measures for settlement of tolls for a vehicle through automatic money transfer.

28. The method as claimed in claim 21, wherein the exhaust gasrelated management operation comprises:
the vehicle management server requesting exhaust gas data of a vehicle from the vehicle data transmitter;
the vehicle data transmitter sending the exhaust gas data to the vehicle management server; and
the vehicle management server analyzing and processing the received data into exhaust gas information by vehicle, vehicle type, manufacturing company, manufacturing year or season, and sending the exhaust gas information to an organ related to exhaust gas so that the organ concerned takes measures related to the exhaust gas of the vehicle.

29. The method as claimed in claim 21, wherein the running record-related management operation comprises:
for a vehicle being under obligation to keep a record of running, the vehicle management server requesting speed data of the vehicle from a vehicle data transmitter;
the vehicle data transmitter sending the requested speed data to the vehicle management server; and
the vehicle management server analyzing and processing the received data into information of the record of running, and sending the information to an organ related to periodic car inspection so that the information can be used as a record of running for periodic inspection of the vehicle.
